(19) United States
(12) Patent Application Publication
(10) Pub. No.: US 2018/0343850 A1
(43) Pub. Date: Dec. 6, 2018

(54) Anti-Bird Perch Attachment for Signs (ABPAS)

(71) Applicant: David Michael Bernacki, Schertz, TX (US)

(72) Inventor: David Michael Bernacki, Schertz, TX (US)

(21) Appl. No.: 15/613,232

(22) Filed: Jun. 4, 2017

(51) Int. Cl. A01M 29/32; F16M 13/02

(52) U.S. Cl. CPC A01M 29/32; F16M 13/02

(57) ABSTRACT

The Anti-bird Perch Attachment for Signs (ABPAS) is a device designed to be attached to signs, of any width and length, which provide a platform for bird spikes to be attached to deter birds from perching on the sign. The ABPAS (claim) is a galvanized piece of sheet metal (18 inch×2.5 inch) bent at 90 degree angle to allow a platform for the attachment of bird spikes. The technical field is the deterrence of birds from public areas and airfields by restricting perching areas on signs to reduce bird populations (technical problem). The solution of the bird problem is to deter birds from perching on signs. The use of the invention is to attach the ABPAS to signs to deter birds from the designated area(s).

### WAS THE INVENTION CREATED UNDER A GOVERNMENT CONTRACT?

No

Invention Accomplishment:

Can be attached to signs with varying widths to allow bird spikes to be attached to the top of the device so perching birds and song birds can be deterred from perching on signs

### DRAWING FIGURES INCLUDED

FIG. 1: device. FIG. 2: size bolt for attachment. FIG. 3: specifications.

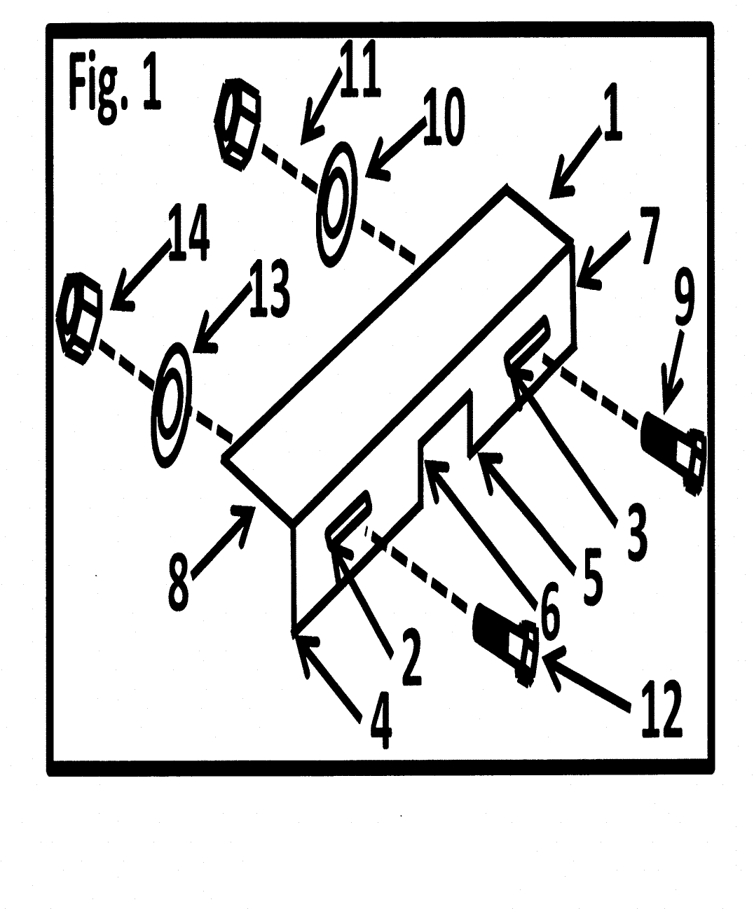

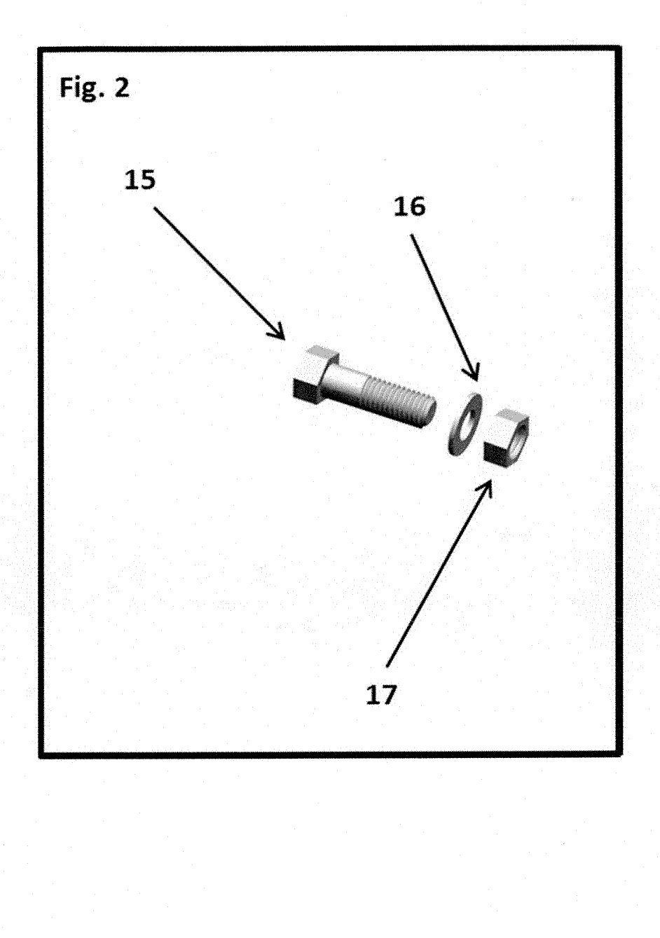

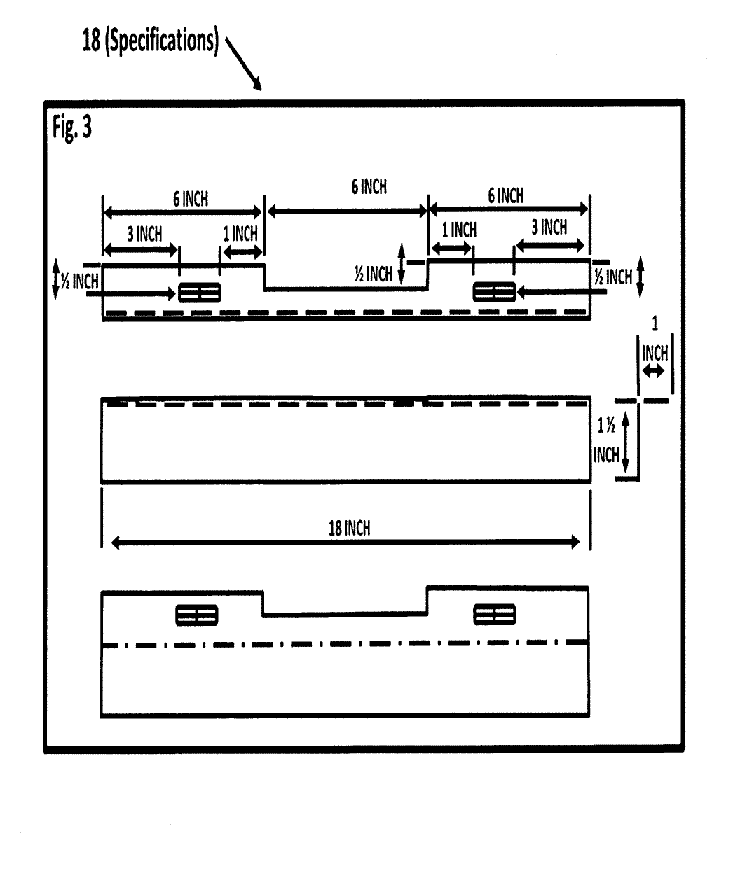

### PARTS AND COMPONENTS

Sheet metal bent at 90 degree angle 1″ from bottom with 1½″ for top, ¼″ bolt, ¼″ washer, and ¼″ nut

Components Connected:

Components (90 degree angle sheet metal) connect by 1¼″×¼″ bolt, ¼″ washer, and ¼″ nut.

Invention Operation:

Drill holes in the sign. Attach Anti-Bird Perch Attachment to sign. Glue bird spikes on top of the attachment.

Other Ways to Construct Invention:

None.

Can Invention be Used in More than One Way?

The attachment can be installed in reverse if the sign is attached to a pole on the back of the sign and the pole is above the sign.

What is claimed is (ABPAS):

1. A galvanized piece of sheet metal (18 inch×2.5 inch).

2. The galvanized piece of sheet metal of claim 1, wherein said galvanized piece of sheet metal is bent at 90 degree angle 1.5 inches from edge.

3. The galvanized piece of sheet metal of claim 2, a 4 inch length and ½ inch height section is cutout in the middle of the length of the length of the structure.

4. The galvanized piece of sheet metal of claim 3, a 2 inch length and ⅜ inch height slot is drilled out between the cutout section and the end of the sheet metal and in the middle of the 90 degree bend and the edge of the sheet metal.

5. The galvanized piece of sheet metal of claim 4, will allow a 1¼ inch×¼ inch bolt, ¼ inch washer, and ¼ inch nut to attach the ABPAS to a sign.
